(19) United States
(12) Patent Application Publication
(10) Pub. No.: US 2023/0121145 A1
(43) Pub. Date: Apr. 20, 2023

(54) METHOD OF INTRODUCING ECOSYSTEM AND METHOD OF MANAGING VALUE INFORMATION ABOUT LAND

(71) Applicant: SUNLIT SEEDLINGS LTD., Kyoto (JP)

(72) Inventor: Yo ONO, Kyoto (JP)

(21) Appl. No.: 17/905,902

(22) PCT Filed: Jan. 8, 2021
(86) PCT No.: PCT/JP2021/000455

§ 371 Date: Sep. 8, 2022

(30) Foreign Application Priority Data
Mar. 20, 2020 (JP) PCT/JP2020/012561
Sep. 16, 2020 (JP) 2020-155897

(51) Int. Cl. G06Q 50/16; G06Q 50/02; A01G 7/00

(52) U.S. Cl. CPC G06Q 50/165; G06Q 50/02; A01G 7/00

(57) ABSTRACT

A method of introducing an ecosystem, the method includes collecting a sample from subject land in which a plant is grown, examining a microbiome in the subject land before starting to grow the plant, the examining the microbiome including DNA analysis on the sample, determining the plant to be grown in the subject land based on a result of the examining the microbiome, and introducing the plant to be grown to the subject land. In the introducing the plant to be grown, the plant has an artificially developed symbiotic relationship to produce a priority effect with a microorganism configured to contribute to growth of the plant to be grown.

### BACKGROUND

### Technical Field

The present disclosure relates to methods of introducing ecosystems and to a system and a method of managing value information about land.

### Description of the Related Art

The statements in this section merely provide background information related to the present disclosure and do not necessarily constitute prior art.

The recent growing interest in global environmental conservation has increased the values of ecosystems including numerous organisms as natural capital. However, factors affecting wild ecosystems are diverse and complex and remain undefined with the latest scientific knowledge. The value of an ecosystem has thus been evaluated by determining the ideal state of a naturally occurring ecosystem in nature.

However, the ideal state of every wild ecosystem can vary, and its economic value cannot be easily quantified uniformly. A method of calculating ecosystem values, known to the inventor, uses a database storing the values of ecosystems each with the state of vegetation identifiable as a characteristic. Based on an input value indicating the state of vegetation in a specific region, the method calculates an ecosystem value for vegetation having a characteristic similar to the characteristic of the input vegetation value (Patent Literature 1).

Patent Literature 1 also describes a method of calculating the future value to be created by an ecosystem. Patent Literature 2 describes a method of evaluating ecosystems that contributes to improving the values of ecosystems. With the values of ecosystems as natural capital increasing as described above, methods have been developed for quantifying or improving the values of ecosystems.

### CITATION LIST

### Patent Literature

Patent Literature 1: Japanese Unexamined Patent Application Publication No. 2019-117613
Patent Literature 2: Japanese Patent No. 6017318

### Non-Patent Literature

Non-Patent Literature 1: Toju, H. et al., Core Microbiomes For Sustainable Agroecosystems. Nature Plants 2018, 4, 247-257.

### SUMMARY

A method of introducing an ecosystem in accordance with some embodiments comprises collecting a sample from subject land in which a plant is grown, examining a microbiome in the subject land before starting to grow the plant, the examining the microbiome including DNA analysis on the sample, determining the plant to be grown in the subject land based on a result of the examining the microbiome and introducing the plant to be grown to the subject land. In the introducing the plant, the plant to be grown has an artificially developed symbiotic relationship to produce a priority effect with a microorganism configured to contribute to growth of the plant to be grown in the subject land.

A method of managing value information about land in accordance with some embodiments comprises redesigning, using a computer system, an ecosystem in subject land to set a target ecosystem and causing the computer system to calculate a target value, and causing the computer system to calculate a current value of the subject land. The target value is a future economic value of the subject land to be produced through introduction of the target ecosystem. The current value is an economic value produced in a process of introducing a current ecosystem, which is an ecosystem constructed in the subject land at a time point during ecosystem reconstruction to introduce the target ecosystem.

### BRIEF DESCRIPTION OF THE SEVERAL VIEWS OF THE DRAWINGS

FIG. 1 is a schematic diagram of a system of managing value information about land according to an embodiment of the present disclosure.

FIG. 2 is a flowchart of information processing using the system of managing value information about land according to the embodiment of the present disclosure.

FIG. 3 is a diagram of an example input screen for inputting information using the system of managing value information about land according to the embodiment of the present disclosure and example information stored in a storage.

FIG. 4 is a table showing example land information stored in an attribute information storage in the embodiment of the present disclosure.

FIG. 5 is a diagram of an example screen to be displayed when redesigning an ecosystem using the system of managing value information about land according to the embodiment of the present disclosure.

FIG. 6 is a table showing example information stored in a redesign information storage in the embodiment of the present disclosure.

FIG. 7 is a table showing example information stored in an ecosystem information storage in the embodiment of the present disclosure.

FIG. 8 is a flowchart of a method of introducing an ecosystem according to an embodiment of the present disclosure.

### DETAILED DESCRIPTION

One or more aspects of the present disclosure are directed to a method of introducing an ecosystem by redefining, redesigning, and reconstructing a wild ecosystem with backcasting.

The method of evaluating the values of ecosystems described in Patent Literature 1 is designed to evaluate, as an economic value, the benefits provided by ecosystems in their naturally occurring state in nature. The method of determining the future values of ecosystems includes predicting a future value by changing a naturally occurring state over time toward the future, without any attempt to artificially manipulate the ecosystem.

The method of evaluating ecosystems described in Patent Literature 2 evaluates the effect of artificial approaches for increasing the values of ecosystems. The evaluation method described in Patent Literature 2 evaluates the potential and apparent value of an ecosystem that can be constructed at the time of evaluation in an area to be evaluated. When the evaluated value is greater than or equal to a predetermined value, an artificial approach is taken against the ecosystem in the area to evaluate the activities resulting from the approach.

The states of wild ecosystems constantly change due to complex intrinsic and extrinsic factors. The full processes of such ecosystems remain undefined scientifically. Artificially designing a wild ecosystem and scientifically controlling its state have been difficult to achieve with the latest scientific knowledge. Thus, known methods use, as with the method described in Patent Literature 2, the state of an ecosystem obtained at the time of evaluation and the evaluation on the state to improve the value of an ecosystem, with forecasting to improve the future value predicted from the present state.

In this situation, research findings are available to provide a first step of scientifically controlling ecosystems (Non-Patent Literature 1). A research finding described in Non-Patent Literature 1 involves identifying a microorganism that determines the function of an entire microbiome (referred to as a core symbiotic microorganism), strengthening the symbiotic relationship between the core symbiotic microorganism and plants, and introducing a plant-microorganism ecosystem that provides intended functions.

Using the research finding described in Non-Patent Literature 1, the inventor has noticed the use of backcasting to first set an ecosystem to be introduced to improve the values of ecosystems. The inventor further uses backcasting to set the appearance and the potential economic value of the ecosystem, and introduces the set ecosystem to improve the economic value of land with a low use value, such as an abandoned crop field or an abandoned forest, thus completing the disclosure.

Ecosystems in certain states naturally occur in the wild. Redefining an ecosystem herein refers to evaluating such a naturally occurring ecosystem for an artificial purpose or with a specific value. Redesigning refers to studying and determining, with backcasting, an ecosystem that meets an artificial purpose or a specific value for a naturally occurring ecosystem. Reconstructing or introducing refers to changing, with backcasting, a naturally occurring ecosystem to an ecosystem in the redesigned state.

Aspects of the present disclosure are directed to an information management system used to improve the value of land by introducing an ecosystem that is set with backcasting and to a method of introducing an ecosystem for improving the economic value of land. Another aspect of the present disclosure is directed particularly to a system of managing economic value information about land to which a redesigned ecosystem is introduced. The information management system according to the aspect of the present disclosure redesigns an ecosystem that can create an intended economic value for land that has an area for economic activities (about 50 square meters or more, or more specifically, 100 square meters or more) and can independently be the subject of land trade. The system stores information for determining the state of the ecosystem during the reconstruction process and the economic value of the ecosystem in the state. The information for determining the state of the ecosystem includes information indicating the physicochemical condition and the biological condition of the ecosystem. Examples of the ecosystem that can create an intended economic value include agroecosystems that produce crops and flowers traded at intended prices, forest ecosystems in forest land in which trees to be lumber grow and in forests that can be tourism resources, ecosystems in artificial green spaces such as parks that have intended economic values, agroforestry ecosystems such as common land in which crops are grown in the presence of trees, and ecosystems for the diversified primary industry including processing and tourism.

In an aspect of the present disclosure, an ecosystem already occurring in a piece of land is redefined. The ecosystem is redesigned to produce an intended economic value. The economic value of the land to which the redesigned ecosystem is being introduced is stored into the information management system. This facilitates determining whether the redesigned ecosystem is reconstructed appropriately and streamlines the process of increasing the economic value of the land to which the redesigned ecosystem is introduced.

A database of plants and animals that can live in land to undergo ecosystem designing can further facilitate redesigning of an intended ecosystem. The database also allows redesigning of an optimal ecosystem based on a complex and broad perspective.

In particular, analyzing the soil of subject land or the plants growing in the soil in redesigning an ecosystem allows identifying the constitution of thousands to tens of thousands of microorganisms (a belowground microbiome and a plant symbiotic microbiome) that live in the land. Redesigning an ecosystem using the microbiome with the technique described in Non-Patent Literature 1 can accelerate the process of reconstructing the ecosystem more efficiently.

In particular, periodically examining the belowground microbiome and the plant symbiotic microbiome during ecosystem reconstruction allows determining the introduced state of the target ecosystem, thus streamlining the management of the reconstruction and maintenance process of the target ecosystem. The target ecosystem redesigned may be modified later as appropriate.

Adjacent pieces of land may be owned by different right holders. In this case, the adjacent pieces of land may be grouped together as a piece of subject land to undergo ecosystem redesign and introduction, with the interests based on land rights being distributed to each right holder. This can eliminate the gap between the artificially defined boundary of land and the boundary defined based on ecological appropriateness to redesign, reconstruct, and maintain and manage the ecosystem.

With the technique according to the above aspects of the present disclosure, the economic value of land with a low economic value may be improved by redesigning the ecosystem in the land with backcasting and reconstructing the designed ecosystem.

Other aspects of the present disclosure are directed to a method or a system of improving the economic value of land with a low economic value by redefining, redesigning, and reconstructing a wild ecosystem with backcasting. A system according to an aspect of the present disclosure is described below.

(1) A system for managing value information about land, the system comprising: an attribute information storage configured to store land information including information about a location of subject land; and

a value information storage configured to store an initial value being an economic value of the subject land in an initial state, a target value being a future economic value of the subject land to be produced through introduction of a target ecosystem set by redesigning an ecosystem in the subject land, and a current value being an economic value of the subject land produced through introduction of a current ecosystem being an ecosystem constructed in the subject land at each of a plurality of time points.

(2) The system according to (1), further comprising:

a future value predictor configured to predict, based on the current value at each of the plurality of time points, a future value of the subject land at a specified time point in future, the future value being an economic value of the subject land to be produced through introduction of the current ecosystem.

(3) The system according to (1) or (2), further comprising:

an ecosystem redesign supporter configured to refer to a redesign information storage storing a plurality of organisms to grow at the location of the subject land and an economic value of each of the plurality of organisms and to the location of the subject land, extract a combination of two or more of the plurality of organisms to be included in the target ecosystem, and calculate an economic value to be produced with organisms of a specified combination living in the subject land.

(4) The system according to any one of (1) to (3), further comprising:

an ecosystem information storage configured to store information about a biological condition of the current ecosystem in the subject land at each of the plurality of time points,

wherein the value information storage or the ecosystem information storage stores ecosystem completion information being information indicating a degree of completion of the current ecosystem in the subject land with respect to the target ecosystem at each of the plurality of time points.

(5) The system according to any one of (1) to (3), further comprising:

an ecosystem information storage configured to store information about a biological condition of the current ecosystem in the subject land at each of the plurality of time points,

wherein the ecosystem information storage stores, as the information about the biological condition, existing microbiome information obtained by analysis on soil of the subject land or a plant growing in the subject land.

(6) The system according to (5), further comprising:

a microbial designer configured to refer to a microbial database storing functional characteristics of a plurality of microorganisms and identify a microorganism beneficial for constructing the target ecosystem.

(7) The system according to any one of (1) to (5), wherein

the attribute information storage further stores right holder information about right holders of adjacent pieces of subject land.

the value information storage stores an initial value and a future value of the adjacent pieces of subject land, and

the system further comprises a right holder manager configured to calculate, in response to a current value calculation request for at least one piece of the adjacent pieces of subject land, a current value of the at least one piece of subject land by referring to the value information storage and the attribute information storage.

One or more embodiments of the present disclosure will now be described with reference to the drawings. The same reference numerals denote the same components, and such components are not described or described briefly.

### System Configuration

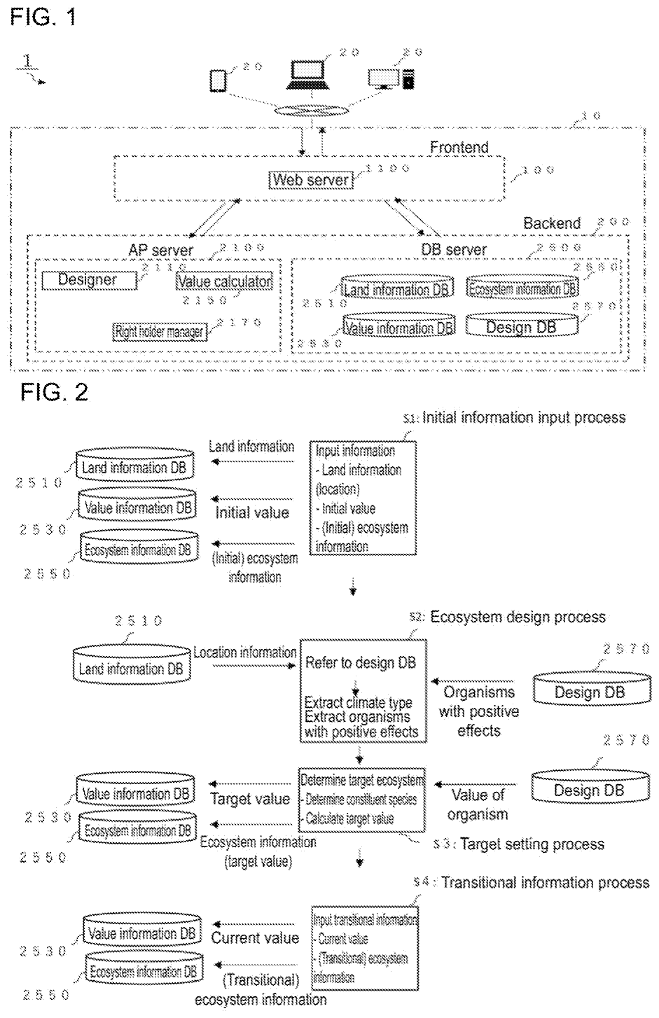

FIG. 1 is a schematic diagram of a land value information management system 1 according to a first embodiment of the present disclosure. The management system 1 includes a business server group 10 and multiple devices 20 used by multiple clients. The business server group 10 includes a web server 1100, an application (AP) server 2100, and a database (DB) server 2500. Each device 20 includes an operation unit, such as a keyboard, a mouse, and a touchscreen (not shown) and a display unit including various displays (not shown). Each device 20 is connected to the business server group 10 with a communication line such as a local area network (LAN), a wide area network (WAN), or the Internet.

The business server group 10 includes a frontend 100 for receiving data and instructions from clients and a backend 200 for performing processes such as data calculation, conversion, storage, and reference based on the received data and instructions. The frontend 100 includes the web server 1100 that provides a user interface (UI) for information exchange with the clients. The backend 200 includes the AP server 2100 for data processing and the DB server 2500 for data processing and referencing. The business server group 10 may include a computer (node) without an operation unit or a display unit, or include a computer (a desktop personal computer, or PC, or a workstation) with an operation unit and a display unit to be used without connection to the devices 20. The land value information management system 1 may include multiple physical servers (cluster) or virtual servers in a cloud environment.

In the management system 1 in the present embodiment, data and instructions from the clients are input into the frontend 100 through the UI from the devices 20. The backend 200 processes, stores, and refers to data in accordance with the instructions, for example. The backend 200 outputs information, which may be transmitted to the device 20 of each client through the frontend 100 and the UI and displayed on the display unit or may be stored into the DB server 2500. Information may be input and output with a storage medium that can be connected directly to the servers, such as a memory card or a universal serial bus (USB). In this case, the UI may be eliminated from the web server. The system may be designed to allow the clients to directly input and output information into and from the AP server and the DB server.

The DB server 2500 in the business server group 10 schematically includes a land information DB 2510 as an attribute information storage. a value information DB 2530 as a value information storage, an ecosystem information DB 2550 as an ecosystem information storage, and a design DB 2570 as an ecosystem redesign information storage. The AP server 2100 schematically includes a designer 2110 that examines the constitution of a microbiome and redesigns an ecosystem, a value calculator 2150 that serves as a future value predictor, and a right holder manager 2170. The designer 2110 in the management system 1 in the present embodiment serves as both an ecosystem redesign supporter and a microbial designer.

Overview of Information Management

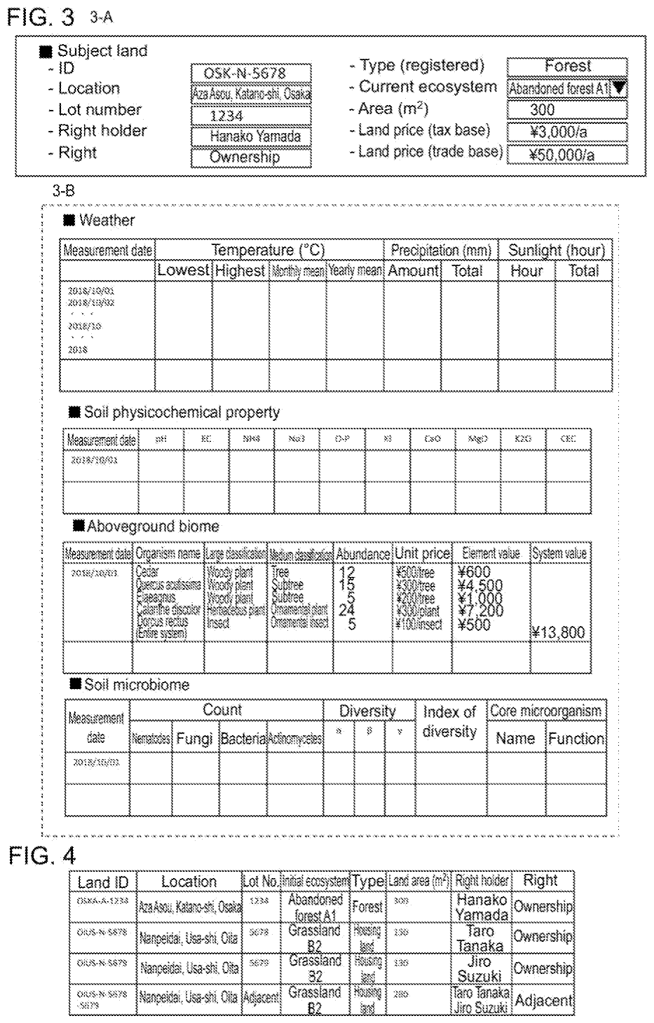

An information processing method of managing value information about land using the management system 1 will be described with reference to FIG. 2. A client of the management system 1 uses a device 20 to input initial information about land subject to ecosystem redesign (S1). The initial information being input includes at least the location of the subject land and its economic value (initial value). The initial information being input may also include information about, for example, the area and the right holder of the subject land and information (ecosystem state information) about the current state of the ecosystem in the subject land (at the time point at which the ecosystem is redesigned). The input information is stored, as a record of the subject land, into the land information DB 2510, the value information DB 2530, or the ecosystem information DB 2550 in the DB server 2500. More specifically, information about land attributes (e.g., the location, the area, and the right holder) may be stored into the land information DB 2510, information about the value of land may be stored into the value information DB 2530, and information about ecosystems may be stored into the ecosystem information DB 2550. A unique identification (ID) is assigned to subject land (refer to FIG. 3) and used as a primary key to uniquely identify the subject land.

In response to the initial information in S1 being input and the business server group 10 receiving a request for redesigning an ecosystem to be reconstructed in the subject land, the designer 2110 refers to the design DB 2570 to extract multiple organisms that can grow in the subject land. The management system 1 uses the design DB 2570 that stores information about ecosystem redesign models for any subject land. More specifically, the design DB 2570 stores information indicating organisms with positive effects for different types of, for example, climates, vegetation, geographic characteristics, and chemical properties of soil. For any combination of organisms with positive effects automatically selected from the input initial information or any combination of organisms pre-specified by a client, the designer 2110 sums up the economic values of the selected or pre-specified organisms to calculate the economic value of the subject land to be produced with the target ecosystem reconstructed and established in the subject land. The calculation or computation performed by the AP server 2100 including the designer 2110 herein refers to outputting a calculated estimate or an approximate value, instead of referring to calculating an actual measurement value representing the actual condition.

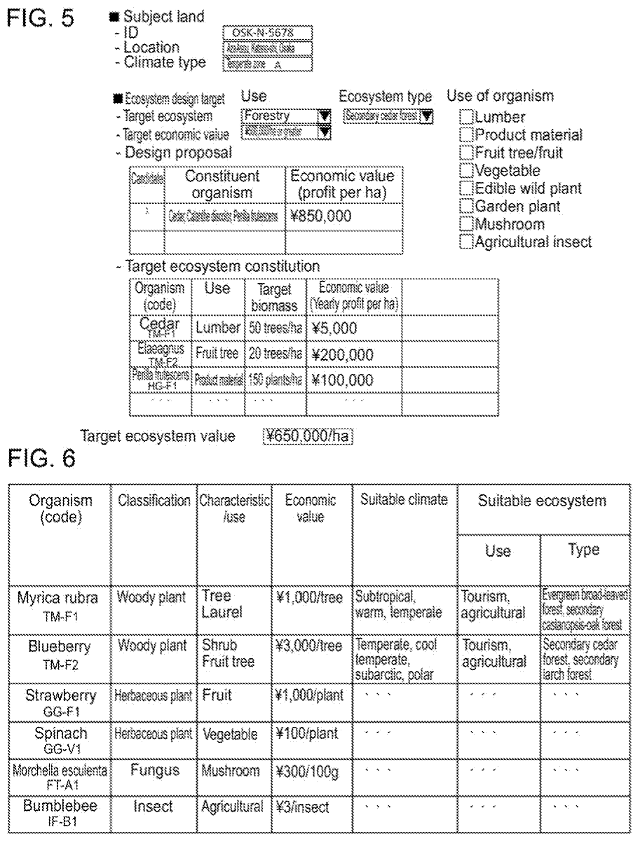

Once the target ecosystem is determined through such an ecosystem redesign process S2, the designer 2110 links information about the determined target ecosystem to information indicating the subject land and stores the liked information into the DB server 2500 (S3). In particular, the designer 2110 stores, into the value information DB 2530, at least the future economic value (target value) to be produced by reconstructing the target ecosystem. The ecosystem state information about the target ecosystem may also be stored into the ecosystem information DB 2550. Examples of the ecosystem state information about the target ecosystem include names and symbols such as IDs to uniquely identify the type of target ecosystem as well as biological and functional characteristics and biological roles in the target ecosystem of one or more species of organisms selected to constitute the target ecosystem. Example types of ecosystems include forest, community forest (Satoyama), grassland, and wetland. These types of ecosystems may be specified by vegetation types and named or labeled with symbols to uniquely identify the ecosystems of different vegetation types (refer to FIG. 5). Names that uniquely identify different forest ecosystem types include, for example, secondary Quercus crispula forest, natural cedar forest, and secondary Quercus serrata forest, which uniquely identify forest ecosystem types using dominant tree species.

The information processing in the ecosystem redesign phase includes information processing performed in each of steps S1 to S3 described above. Subsequent to the ecosystem redesign, information processing (transitional information process S4) is performed during reconstruction of the redesigned ecosystem in the subject land.

The process of reconstructing a designed ecosystem includes establishing the organisms that constitute the target ecosystem in the subject land to introduce the target ecosystem. In this process, ecological surveys about the subject land are conducted. The transitional information process S4 is performed based on information (ecosystem state information) obtained from the surveys.

In the transitional information process S4, the ecosystem state information about the current ecosystem is obtained at each of the time points at which multiple ecological surveys are performed. The value calculator 2150 calculates, based on the obtained ecosystem state information, the economic value (current value) of the current ecosystem. The calculated current value is stored into the value information DB 2530.

Initial Information Input Process

The information processing in steps will now be described in detail. In the initial information input process S1, the attribute information about the land to undergo ecosystem redesign and the economic value of the land before ecosystem redesign are input and stored into the DB server 2500. The ecosystem state information about the subject land before ecosystem redesign may also be obtained and stored into the DB server 2500.

FIG. 3 shows an example input screen for information input in the initial information input process S1. A client uses, for example, a device 20 to cause the display unit to display the input screen shown in FIG. 3 and inputs attribute information about the subject land to undergo ecosystem redesign. A portion (3-A) indicated by the solid line in FIG. 3 is a record entry in the land information DB 2510, and a portion (3-B) indicated by the dashed line is a record entry in the ecosystem information DB 2550.

The attribute information about the subject land may include location information about the subject land to identify the climate at the subject land (substantially at the neighborhood level). The location information may be stored into the land information DB 2510. The attribute information other than the location information to be stored may include the lot number, the area of land (area), the land type, the right holder, and the details of the right, which are items of registration information.

FIG. 4 is an example table of land information stored in the land information DB 2510. In the example shown in FIG. 4, the land IDs assigned to identify the climate at the subject land (substantially at the neighborhood level) are used as primary keys to uniquely identify the subject land. More specifically, each land ID at the leftmost column includes a location code such as OSKA-A, with the first two-digit symbol OS indicating the prefecture, the next two-digit symbol KA indicating the municipality, and the one-digit symbol A after a hyphen indicating the location at the neighborhood level.

The information to be input in the initial information input process S1 includes the location of the subject land and its economic value (initial value) in its initial state before undergoing ecosystem redesign. The initial value may be the registered value of the subject land or may be determined based on the actual condition of the subject land. For the initial value being the registered value, the land price used as the basis for the fixed asset calculation is input. For the initial value determined based on the actual condition, the land price calculated for trading the subject land is input.

The information described above can be obtained and input without any ecological survey about the subject land. The initial information input process S1 may include inputting information that can be input without any ecological survey (attribute information input step) and inputting information obtained from ecological surveys (ecosystem state information input step).

The information obtained from ecological surveys includes information about the physicochemical condition and the biological condition of the subject land. The information about the physicochemical condition includes weather information that affects the temperature and moisture conditions of the subject land (information about temperature, precipitation, and sunlight) and information indicating the physicochemical condition of the soil of the subject land (soil physicochemical information). The weather information can be obtained and input from various known weather information databases. The soil physicochemical information can be obtained and input through known soil diagnostics. The soil physicochemical information includes, for example, a pH, electrical conductivity (EC), an ammonia nitrogen concentration, a nitrate nitrogen concentration, an organic phosphate concentration, an exchangeable potassium concentration, a phosphate absorption coefficient, an exchangeable lime concentration, an exchangeable magnesia concentration, an exchangeable manganese concentration, an available iron concentration, an available copper concentration, an available zinc concentration, a boron concentration, a cation exchange capacity (CEC), a humus content, and soil texture.

The information about the biological condition includes information about aboveground biome information and belowground biome information. The aboveground biome information to be obtained and stored into the ecosystem information DB 2550 may include identifying information (e.g., names) for uniquely identifying each of major plants, animals, and other organisms that constitute the aboveground ecosystem as well as the abundance of each of such plants, animals, and other organisms. The abundance may be an estimate obtained based on a survey or by calculation (the same applies hereafter). The major plant and animals that constitute the aboveground ecosystem include plants and animals that characterize the ecosystem or plants and animals (selected organism) selected as organisms that constitute the target ecosystem. The organisms that characterize the ecosystem include organisms (dominant organisms) that are dominant in an ecosystem and plants and animals (representative organisms) with their abundance being greater than or equal to a predetermined level. The other organisms include microorganisms that live symbiotically (including parasitism, mutualism, and opportunistic infection) in plants, animals, and other organisms. In the initial information input process S1, the selected organism has yet to be determined, and thus information about the representative organism or dominant organism is obtained. The identifying information that uniquely identifies an organism may be a name or a symbol, with its classification hierarchy being specified by any hierarchy selected as appropriate, such as family, genus, species, subspecies, or lineage.

The AP server 2100 in the management system 1 includes the value calculator 2150. The value calculator 2150 refers to a database (the design DB 2570 in the present embodiment) storing the economic value of each organism constituting an ecosystem and calculates the current economic value of the ecosystem (initial ecosystem) in the subject land based on the input initial information. In the present embodiment, the economic value, and the climate and ecosystem type with positive effects are stored for each organism in the design DB 2570 shown in FIG. 6. The value calculator 2150 refers to the value information DB 2530 and the design DB 2570 based on the names of multiple organisms that constitute the initial ecosystem input as aboveground biome information and calculates the economic value of each organism by multiplying the abundance by the corresponding value (unit price). The value calculator 2150 also sums up the economic values calculated for the organisms and calculates the economic value of the initial ecosystem in the subject land (initial ecosystem value).

The belowground biome includes soil animals of the size that can be identified by the naked eye, such as springtails and earthworms, and microorganisms called belowground microorganisms (microorganisms included in a soil microbiome and a symbiotic microbiome at the belowground parts of plants), such as fungi (synonymous with filamentous fungi herein), bacteria, actinomycetes, and protists including algae and nematodes. Information about belowground microorganisms of the organisms included in the belowground biome may particularly be obtained as the belowground biome information and stored into the DB server 2500 (ecosystem information DB 2550). Example items of the information about belowground microorganisms include the number of animals per unit volume (or weight) of soil or plant roots, the number of cells (or estimates in colony-forming units or DNA content) of fungi, bacteria, or actinomycetes, and the diversity (α-diversity, β-diversity, γ-diversity) of species and other taxonomic classes (operational taxonomic units and amplicon sequencing variants can also be used as a substitute) of these organisms. The information about belowground microorganisms may be stored into the DB server 2500 (ecosystem information DB 2550) together with identifying information (e.g., names) for identifying the microorganisms (core microorganism) that benefit the construction of a target ecosystem and the notable functional characteristics (e.g., growth promotion for a plant A and reducing damage by an insect B) of such organisms. The core microorganism is identified in microbiome design described later.

### Ecosystem Redesign Process

The ecosystem redesign process S2 will now be described. FIG. 5 shows an example screen appearing on a device 20 when a client redesigns an ecosystem. The client uses the device 20 to cause the display unit to display the screen for designing shown in FIG. 5 and inputs the design target. The design target is at least one of information about the ecosystem to be redesigned (the type, the constituent species, or both) or the economic value to be produced by reconstructing the target ecosystem. In the present embodiment, both the target ecosystem and the economic value are set as design targets. For the ecosystem, the use, the type of ecosystem, and the species constituting the ecosystem can be specified.

Upon receiving the input of the ecosystem design targets from the device 20, the designer 2110 extracts the items for redesigning the ecosystem (information for design) from the input values input as design targets and selects a combination (ecosystem redesign model) of organisms with positive effects having conditions matching the item extracted with reference to the design DB 2570. The information for design extracted by the designer 2110 for ecosystem redesign may be information specifying the climate type and the ecosystem type of the subject land and the functional characteristics of the organisms that constitute the ecosystem in the subject land. In the example shown in FIG. 5, the climate type of the subject land is identified using a known database based on the location information about the subject land. The designer 2110 uses this climate type information as well as the ecosystem type and the constituent organism information specified by the client as conditions to create a combination of organisms that match the conditions from the design DB 2570. The value calculator 2150 then calculates the economic value of the created combination of the organisms and outputs the combination of organisms that satisfies the target economic value conditions specified by the client and the economic value to be produced from the combination as a design proposal for the ecosystem redesign model, which is then displayed on the device 20.

### Target Setting Process

The client specifies organisms that constitute the target ecosystem by referring to the design proposal output through the ecosystem redesign process and determines the constitution of the target ecosystem. In this step (target setting process S3), the management system 1 generates information about the target ecosystem and stores the information into the DB server 2500 in the manner described below.

In response to the business server group 10 receiving the determination of the target ecosystem from the client, the value calculator 2150 sums up the economic values of the organisms that constitute the determined target ecosystem and calculates the economic value (target value) to be produced with the target ecosystem reconstructed in the subject land. The target value can be calculated by multiplying the target abundance of each organism constituting the target ecosystem in the target ecosystem by the unit value of the target abundance and adding up the resultant values.

The designer 2110 in the management system 1 in the present embodiment can identify beneficial microorganisms for introduction of the target ecosystem based on the initial microbiome information. More specifically, the designer 2110 uses at least one of the soil of the subject land or the plants growing on the subject land as an analysis sample in the initial information input process S1, obtains the biological information about the microbiome contained in the sample, and stores the information into the ecosystem information DB 2550. Once candidates for organisms that constitute the target ecosystem are determined, the designer 2110 identifies a microorganism (core microorganism) that contributes to at least one of the establishment or the growth of the organisms that constitute the target ecosystem using a known annotation tool for estimating the potential functions of the microorganisms based on the biological information about the microbiome stored in the ecosystem information DB 2550 and the gene sequence information derived from each microorganism.

In the present embodiment, the client determines, from the candidate selected organisms identified by the designer 2110, a selected organism by referring to the belowground biome information. For example, the selected organism selected from the candidate selected organisms may be an organism estimated to easily establish in the subject land or may be an organism determined based on the operability and the function of the core microorganism identified by the designer 2110 for each candidate selected organism.

The core microorganism may be identified in the manner described in Japanese Patent Application No. 2020-039972. The designer 2110 identifies the core microorganism using, in accordance with the manner described in Japanese Patent Application No. 2020-039972, gene sequence information about various microorganisms and a known microbial database storing the potential functions of the microorganisms determined from the gene sequence information. Identifying the core microorganism herein refers to finding a microorganism estimated to be a core microorganism through a calculation process of estimating a microorganism that can function as a core microorganism based on the gene sequence information about microorganisms. The identified core microorganism is, for example, inoculated into the organism (selected organism) that constitutes the target ecosystem to develop the symbiotic relationship with the selected plant and produce a priority effect with the selected plant. The core microorganism introduced to the subject land in the above manner improves the survival rate and the growth of the selected organism and facilitates introduction of the target ecosystem.

The target value calculated by the value calculator 2150 is stored into the value information DB 2150. Other items of information about the target ecosystem used to calculate the value of the target ecosystem, or more specifically, information about the organisms that constitute the target ecosystem may also be stored into the value information DB 2150 or linked to the information stored in the ecosystem information DB 2550. The information about organisms constituting the target ecosystem may include an identifier such as a name that uniquely identifies each organism and the target biomass of each organism. Information (e.g., functional characteristics) about the core microorganism may also be stored into the DB server 2500. Information about ecosystems other than information about the values of the ecosystems may be stored into any storage medium.

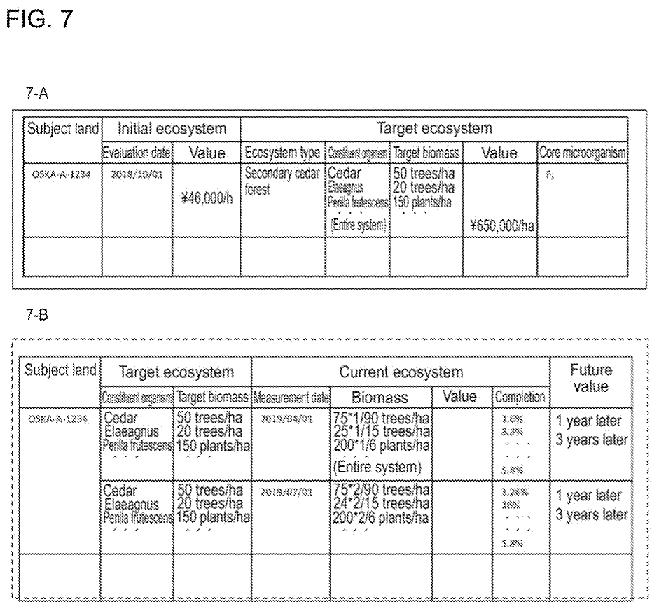

FIG. 7 shows example information stored in the value information DB 2150. A portion indicated by solid line 7-A is the information input and stored (in the initial information input process S1 and the target setting process S3) before the target ecosystem starts being constructed. A portion indicated by dashed line 7-B is the information input and stored (in the transitional information process S4) after the target ecosystem starts being constructed.

### Transitional Information Process

The transitional information process S4 is performed at multiple time points during reconstruction of the target ecosystem. The transitional information process S4 includes processing information indicating the state of the redesigned ecosystem (current ecosystem) being reconstructed in the subject land. An ecological survey is thus conducted in the subject land before information processing is performed in the transitional information process S4. The information about the current ecosystem obtained based on the survey is used as an input value. Ecological surveys in the subject land are conducted at intervals set appropriately for determining the introduced state of the target ecosystem (e.g., every few months for a forest and every few weeks for a crop field).

Each of the ecological surveys at multiple time points may be conducted to obtain soil physicochemical information and information about biological conditions (in particular, information about the biological conditions of the aboveground and belowground microbiomes in each of the surveys at multiple time points). Weather information may be obtained at any time using, for example, various sensors or may be obtained from known weather information services to be stored into the ecosystem information DB 2550 as the transitional information process S4 is performed.

The belowground microbiome information can be used to, for example, confirm that the soil microbiome is developing appropriately for introducing the target ecosystem or to inoculate additional microorganisms that can promote, for example, the growth of the selected plant and protect the plant from organisms that can damage the plant.

The aboveground biome information includes the abundance of at least one species of selected organism in the current ecosystem as an input value used in the transitional information process S4. The value calculator 2150 refers to one or more of the value information DB 2530, the ecosystem information DB 2550, or the design DB 2570 as appropriate and calculates the current value of the current ecosystem based on the biomass of the selected organism in the current ecosystem and the economic value of the selected organism. The biomass may also be estimated based on calculation or surveys (the same applies hereafter). In the present embodiment, ecological surveys are conducted several times before profit is yielded for organisms selected in ecosystem redesign. The selected organism is evaluated for the degree of fulfilling its role expected in the target ecosystem (degree of completion of the selected organism) based on information such as about the biomass of the selected organism in the current ecosystem. The value calculator 2150 calculates the economic value of the current ecosystem using the degree of completion of the selected organism in the current ecosystem. In the example shown in FIG. 7, the economic value of a selected organism (cedar) that involves three ecological surveys each year for 30 years before yielding profit is calculated by modifying the biomass of the selected organism by the amount of growth (1/3 times 30 years) of the selected organism in each survey.

For multiple selected organisms, the value calculator 2150 calculates the economic value of each selected organism by using the biomass of each selected organism in the current ecosystem as an input value, referring to the design DB 2570 to retrieve the economic value of each selected organism, and modifying the biomass in the above manner as appropriate. The value calculator 2150 then sums up the economic values of the selected organisms to calculate the value (current value) of the current ecosystem. Any organism (nonselected organism) having an economic value other than the selected organisms in the current ecosystem may be added to the constituent organisms. The value calculator 2150 may add the economic value based on the abundance of the nonselected organism to calculate the current value. The current value calculated by the value calculator 2150 is stored into the value information DB 2530.

The value calculator 2150 may further be designed to output information about the degree of completion of an ecosystem. More specifically, the degree of completion of the current ecosystem with respect to the target ecosystem is calculated by calculating the difference between the number of species and the biomass of each selected organism in the target ecosystem and the number of species and the biomass of each selected organism in the current ecosystem. Although the information about the degree of completion of the current ecosystem is stored into the value information DB 2530 in the present embodiment, the information may be stored into the ecosystem information DB 2550.

When the value information DB 2530 stores multiple current values together with time-series information, the value calculator 2150 in the present embodiment can predict, based on the multiple current values and the time-series information, the value of the ecosystem reconstructed (or being reconstructed) at a specified time point in the future as a future value. The value calculator 2150 uses statistical modeling to infer the future value based on, for example, multiple current values and the time-series information (measurement dates and measurement intervals) of the current values. Statistical modeling for predicting the future value of the current ecosystem also includes reference to information about the degree of completion of the current ecosystem at a time point with respect to a target ecosystem to improve the accuracy of the prediction.

Managing Information about Adjacent Pieces of Subject Land

In the land information DB 2510 in FIG. 4, multiple pieces of subject land (with land IDs of OIUS-N-5678 and OIUS-N-5679) adjacent to each other owned by different right holders are grouped together as one subject (adjacent pieces of subject land) to undergo ecosystem redesign. In the initial information input process S1, attribute information (an ID to identify pieces of land as adjacent pieces of subject land in the same group, the area as a group of adjacent pieces of subject land, and all the right holders) of each piece of subject land included in adjacent pieces of subject land is stored into the land information DB 2510. The target ecosystem is redesigned using the adjacent pieces of subject land having the same ID as the smallest unit. The initial value, the current value, the future value, and the target value are then calculated for each group of adjacent pieces of subject land and stored into the value information DB 2530.

The right holder manager 2170 receives, for a piece of subject land specified by the client of the pieces of subject land included in the group of adjacent pieces of subject land, a request for calculating the current value of the ecosystem reconstructed in the specified piece of the adjacent pieces of subject land. In this case, the right holder manager 2170 refers to the land information DB 2510 and calculates the current value of the current ecosystem in the specified piece of subject land by dividing the current value of the adjacent pieces of subject land by the percentage of area occupied by the specified piece of subject land. Multiple pieces of subject land adjacent to each other and owned by different right holders may be managed as adjacent pieces of subject land in the manner described above to allow redesign and reconstruction of an ecosystem across the artificial boundary set for registration. This allows distribution of the economic value to be produced with the redesigned, reconstructed ecosystem to the right holders of the subject land included in the adjacent pieces of subject land.

In the management system 1, the DB server 2500 includes databases (the land information DB, the value information DB, the ecosystem information DB, and the design DB) each for a different item of information. The databases may be included in an external server, rather than in the business server group 10 alone. Each database may be structured in a manner other than in the present embodiment.

### Method of Introducing Ecosystem

Another aspect of the present disclosure relates to a method of introducing an ecosystem redesigned with backcasting. The method of introducing the ecosystem according to one embodiment of the present disclosure includes introducing an ecosystem to land with a low economic value, such as an abandoned field, determining the economic value the land at the time point at which the economic value of the land is low, and performing an ecological survey about the land at the time point. The method may then obtain, based on the obtained ecological survey results, information about the existing microbiome in the surveyed land.

The physicochemical conditions of the land (e.g., climate, soil conditions, and topography) are used to identify agricultural and forest products that are easy to grow on the land and appropriate for market trade to redesign the ecosystem that includes organisms that are easy to grow with low maintenance costs and facilitate harvesting agricultural and forest products. The method may then include identifying the core microorganism that is beneficial for introducing the redesigned ecosystem, performing a process (hereafter, symbiotic system introduction process) to cause the core microorganism to develop a symbiotic relationship and produce a priority effect with a plant (selected plant) mainly used to introduce the redesigned ecosystem, and starting introducing the redesigned ecosystem.

The symbiotic system introduction process includes, for example, inoculating the seeds of the selected plant with the core microorganism and germinating the resultant seeds to raise seedlings, planting seedlings obtained by, for example, germinating the seeds of the selected plant or raising the seedlings of the selected plant in culture soil inoculated with the core microorganism into the subject land, germinating the seeds in culture solution inoculated with the core microorganism, planting rooted selected plant into the subject land, covering the radicle of the selected plant with a material in which the core microorganism is dominant, and mixing a material such as culture soil containing the core microorganism into the soil in which the selected plant is growing. Non-Patent Literature 1 describes identifying a core microorganism and performing the symbiotic system introduction process to artificially introduce a symbiotic relationship between a selected plant and the core microorganism.

The core microorganism may be a microorganism present in the subject land. The use of a microorganism present in the subject land as a core microorganism is expected to increase the reliability of reintroducing an ecosystem in the subject land. The core microorganism used may also be a microorganism that lives outside the subject land and is estimated to be useful for ecosystem introduction at the subject land.

For example, for the subject land being bare land, the core microorganism used may be a microorganism that lives in an ecosystem (a forest ecosystem or an agroecosystem) including plants and occurring in land adjacent to the bare subject land. More specifically, for bare subject land resulting from landslides, the core microorganism used may be a microorganism that lives in an ecosystem within a radius of about 5 to 10 km from the land.

In another example, the core microorganism used may be a microorganism that lives in an ecosystem occurring in an environment expected to be similar to the environment in the subject land. The environment expected to be similar to the environment in the subject land has a physical environment, such as a climate zone and topography, substantially equal to the physical environment in the subject land. For example, a wilderness in Hokkaido and a wilderness in North America with similar climatic conditions are expected to have a substantially equal physical environment.

The core microorganism living outside the subject land may be a microorganism in an environment near the subject land or in an environment expected to be physically similar to the environment in the subject land, in which the established aboveground ecosystem includes a selected plant to constitute the target ecosystem as a dominant organism or a representative organism.

The method of introducing the ecosystem according to one or more embodiments of the present disclosure uses identification of a core microorganism and the symbiotic system introduction process using the core microorganism described in Non-Patent Literature 1 to introduce the ecosystem redesigned with backcasting. In one or more embodiments of the present disclosure, after the redesigned ecosystem is started to be introduced, ecological surveys about the subject land are conducted as appropriate to perform the symbiotic system introduction process.

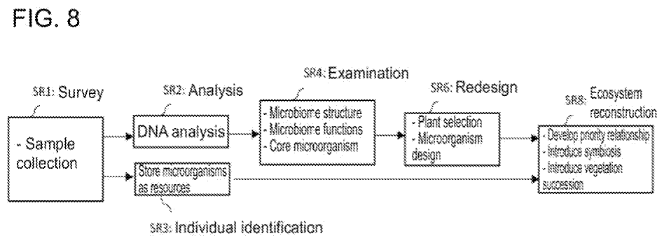

A method of introducing an ecosystem according to another embodiment of the present disclosure will now be described with reference to FIG. 8. With the method of introducing the ecosystem according to the present embodiment, the first step (survey step SR1) includes conducting an ecosystem survey and collecting samples from the subject land to undergo ecosystem redesign. The range and the location of collecting the samples may be determined as appropriate for the subject land. The samples include at least the sedimentary organic layer (layer A) of the soil in the subject land and may include up to a layer M from a layer A of the mineral soil layer. In addition to soil, plant roots in the soil may also be sampled. In survey step SR1, an aboveground ecosystem survey may be conducted about vegetation and living animal species in the subject land to identify a dominant organism or a representative organism and identify the initial aboveground ecosystem before redesigning an ecosystem in the subject land.

The samples obtained in survey step SR1 are partly subjected to DNA analysis (analysis step SR2) and partly stored as resource microorganisms (individual identification step SR3). Any commonly available DNA analysis service may be used. In the individual identification step SR3, some of the samples are used to isolate microorganisms contained in the samples by a common microorganism isolation method (isolation step). The isolated microorganisms are classified and identified by DNA analysis, morphological observation, or other methods to define the physiological and ecological functions of the microorganisms. The microorganisms are thus stored as a collection of microbial resources with their functions and other characteristics being identified.

The analysis data obtained in analysis step SR2 is examined in examination step SR4 using an examination method described in, for example, Non-Patent Literature 1 to examines the structure and the functions of the belowground microbiome in the subject land. The findings about the belowground microbiome in the subject land obtained in examination step SR4 can be used for ecosystem redesign in redesign step SR6. In other words, a plant compatible with the belowground microbiome in the subject land can be estimated based on the information about the belowground microbiome in the subject land obtained in examination step SR4. More specifically, the core microorganism is identified for candidate selected plants with the method described above, and the compatibility between candidate selected plants and the belowground microbiome in the subject land is examined based on the belowground microbiome information with reference to a publicly available biogenetic information database and information from various works of literature.

In redesign step SR6, a plant compatible with the microbiome obtained from the examination performed in examination step SR4 is thus selected from the plants (candidate selected plants) to be grown in the subject land. The plant (selected plant) to constitute the ecosystem to be introduced in the subject land and the order of introducing the plant are determined. In some embodiments, the plant (selected plant) to be grown in the subject land may be determined first, the microorganism (core microorganism) beneficial to the plant may then be identified, and the identified core microorganism and the target plant may be introduced to develop a symbiotic relationship.

Redesign step SR6 includes determining a selected plant and the time to introduce the selected plant to the subject land. For multiple plants to be introduced, the plants may be introduced at intervals from a few weeks to months or years to reflect the vegetation succession that may occur in the subject land. More specifically, for bare subject land that has collapsed by a disaster, the design may include a first stage of seeding herbaceous plants, followed by a second stage of planting medium shrub trees a few months to a few years after the herbaceous plants have flourished.

Subsequently to redesign step SR6, the selected plant determined in redesign step SR6 is established in the subject land to construct an ecosystem (ecosystem reconstruction step SR8). In ecosystem reconstruction step SR8, the symbiotic system introduction process may be performed to artificially develop the symbiotic relationship that produces a priority effect between the selected plant and the core microorganism beneficial to establish the selected plant in the subject land. The priority effect may be used to introduce the redesigned ecosystem. The priority effect produced between a plant and a microorganism refers to a previously developed symbiotic relationship obstructing development of a later symbiotic relationship between a microorganism and a plant.

The symbiotic system introduction process may be performed in the manner described above. In the present embodiment, the microorganisms in the subject land are stored as resources in the individual identification step SR3. A microorganism stored as a resource may be used as a core microorganism. The use of a microorganism present in the subject land as a core microorganism is expected to increase the reliability of ecosystem reintroduction in the subject land. As described above, the core microorganism may also be a microorganism that lives outside the subject land and is estimated to be useful for ecosystem reintroduction at the subject land.

In some embodiments of the present disclosure, an ecosystem is designed (ecosystem redesign) based on the information about the microbiome in the subject land obtained through surveys about the subject land (sample collection) and DNA analysis, with profit (economic) targets set to be obtained in months, years, or decades, as in the present embodiment. In ecosystem reconstruction step SR8, the selected plant determined as a plant compatible with the microbiome in the subject land is established in accordance with a redesigned plan to artificially introduce the redesigned target ecosystem. In ecosystem reconstruction step SR8, the selected plant having an artificially introduced symbiotic relationship with the core microorganism may be introduced to the subject land to produce a priority effect. For example, the selected plant may be germinated and raised in culture soil in which the core microorganism is dominant. The seedling of the plant thus having the priority effect is planted into the subject land.

The ecosystem introduced in ecosystem construction step SR8 is the target ecosystem that is set in redesign step SR6 as the ecosystem that produces an intended economic value for the subject land. For the subject land being agricultural land, for example, the target value can be the annual gross revenue per unit area of crops to be cultivated on the subject land. A crop that can yield the annual gross revenue set with reference to the belowground biome information is planted as a plant (selected plant) or crop to constitute the ecosystem (agroecosystem) to be introduced to the subject land.

In the present embodiment, in redesign step SR6, the crops (candidate selected plants) that can yield the set annual gross profit (economic value) are examined for compatibility with the microbiome in the subject land using the examination result obtained in examination step SR4 to determine a crop (selected plant) to be actually planted. For example, a crop compatible with the microbiome in the subject land is selected as the selected plant in examination step SR4 from multiple candidates of selected plants that can yield substantially the same annual gross profit.

In redesigning step SR6, when introducing (planting) the crop determined as the selected plant that constitutes the target ecosystem (agroecosystem) designed based on the target value of the subject land and the compatibility with the microbiome, a crop having an artificially introduced symbiotic relationship with the core microorganism (e.g., seedlings cultivated in culture soil containing the core microorganism) may be introduced, as described above. The priority effect to be produced with the artificially developed symbiotic relationship between the crop to be planted and the core microorganism allows the crop being planted to easily form a plant-microorganism symbiotic network in the subject land to have high stress tolerance and appropriate nutrient requirements.

A method of introducing an ecosystem according to still another embodiment of the present disclosure will now be described. The method is directed to artificially constructing an agroforestry ecosystem in which a combination of agriculture and forestry (agroforestry) is performed. Agroforestry land herein refers to land used for agroforestry management in which crops are cultivated in the presence of trees. With the method of introducing the ecosystem according to the present embodiment, the succession of an aboveground plant ecosystem is artificially designed. The designed ecosystem is then artificially introduced. In designing an ecosystem in the present embodiment, a target ecosystem with an intended economic value for the subject land is set for each stage of the designed succession.

More specifically, a first stage includes, for example, introducing an ecosystem mainly including herbaceous plants that provide fodder, a fertilizer, food, or a nectar source (referred to herein as an herbaceous ecosystem). A second stage includes introducing an ecosystem mainly including shrubby plants that have edible or ornamental uses (referred to herein as a shrub ecosystem). The final stage includes artificially introducing a forested ecosystem including trees to be lumber (referred to herein as a tree ecosystem).

With the method of introducing the ecosystem according to the present embodiment, the survey, analysis, examination, and redesign described above are performed on the subject land before any ecosystem is introduced to design different ecosystems each with an intended economic value to be introduced during the succession from the first stage to the final stage. Each ecosystem is redesigned in the same manner as with the method of introducing the ecosystem according to any of other embodiments of the present disclosure. The selected plant that constitutes the target ecosystem is determined based on the target value of the ecosystem to be introduced and the compatibility with the belowground biome in the subject land.

After being redesigned, the ecosystems are introduced in sequence. Each ecosystem is introduced in the same manner as with the method of introducing the ecosystem according to any of the other embodiments of the present disclosure. In other words, the selected plant that constitutes the target ecosystem is introduced to the subject land to develop an artificial symbiotic relationship with the core microorganism and produce the priority effect with the core microorganism.

When artificially designing and introducing ecosystem succession in the manner described above, the plant having an artificially developed symbiotic relationship with the core microorganism may be introduced to the subject land by, for example, seeding or planting, depending on the stage of the succession artificially introduced. Microorganisms beneficial to the development of the redesigned ecosystem may be introduced to the subject land as appropriate to enhance the development of the redesigned ecosystem. More specifically, culture solutions of microorganisms beneficial to the development of the redesigned ecosystem or the culture soil in which such microorganisms are cultivated may be placed into the subject land.

In the manner described above, the economic value of subject land is improved by obtaining information about the ecological state of a redesigned ecosystem while the ecosystem is being introduced and by calculating the economic value of the ecosystem constructed at time points while the ecosystem is being introduced.

### INDUSTRIAL APPLICABILITY

The system of managing value information about land in one or more embodiments of the present disclosure is usable to improve the economic value of land by introducing, to an ecosystem occurring in a natural environment, an ecosystem designed with backcasting as an ecosystem with an intended economic value. The technique according to one or more embodiments of the present disclosure is directed to land unused for economic activities and having a low substantial economic value, such as an abandoned forest and devastated agricultural land. The technique is used to redesign an ecosystem appropriate for harvesting crops, fruits, lumber, and wild plants that are traded in, for example, agricultural markets and introduce designed community forest (Satoyama) or agroforestry land (agroforestry forest).

### REFERENCE SIGNS LIST

1 land value information management system
10 business server group
100 frontend
200 backend
2110 designer (ecosystem redesign supporter and microbial designer)
2150 value calculator (future value predictor)
2170 right holder manager
2510 land information DB (attribute information storage)
2530 value information DB (value information storage)
2550 ecosystem information DB (ecosystem information storage)
2570 design DB (redesign information storage)

What is claimed is:

1. A method of introducing an ecosystem, the method comprising:
collecting a sample from subject land in which a plant is grown;
examining a microbiome in the subject land before starting to grow the plant, the examining the microbiome including DNA analysis on the sample;
determining the plant to be grown in the subject land based on a result of the examining the microbiome; and
introducing the plant to be grown to the subject land, the plant to be grown having an artificially developed symbiotic relationship to produce a priority effect with a microorganism, the microorganism being configured to contribute to growth of the plant to be grown in the subject land.

2. The method according to claim 1, wherein
the determining the plant to be grown in the subject land includes determining the plant to be grown as a plant to change an ecosystem to undergo the introducing the plant to be grown to the subject land into a target ecosystem, and the target ecosystem is set as an ecosystem producing a predetermined economic value for the subject land.

3. The method according to claim 1, wherein
the sample includes soil, and the microorganism includes a soil microorganism.

4. The method according to claim 3, wherein
the microorganism includes a fungus.

5. The method according to claim 4, wherein
the sample includes a plant root, and the microorganism includes a fungus to form a symbiotic network with a root of the plant to be grown in soil.

6. The method according to claim 1, wherein
the ecosystem includes an agroecosystem in which a plant is cultivated.

7. The method according to claim 1, wherein
the ecosystem includes a forest ecosystem.

8. The method according to claim 1, wherein
the ecosystem includes an agroforestry ecosystem in which a crop is grown in presence of a tree.

9. A method of managing value information about land, the method comprising:
redesigning, using a computer system, an ecosystem in subject land to set a target ecosystem and causing the computer system to calculate a target value, the target value being a future economic value of the subject land to be produced through introduction of the target ecosystem; and
causing the computer system to calculate a current value of the subject land, the current value being an economic value produced in a process of introducing a current ecosystem, the current ecosystem being an ecosystem constructed in the subject land at a time point during ecosystem reconstruction to introduce the target ecosystem.

10. The method according to claim 2, wherein
the sample includes soil, and the microorganism includes a soil microorganism.

11. The method according to claim 10, wherein
the microorganism includes a fungus.

12. The method according to claim 11, wherein
the sample includes a plant root, and the microorganism includes a fungus to form a symbiotic network with a root of the plant to be grown in soil.

13. The method according to claim 2, wherein
the ecosystem includes an agroecosystem in which a plant is cultivated.

14. The method according to claim 2, wherein
the ecosystem includes a forest ecosystem.

15. The method according to claim 2, wherein
the ecosystem includes an agroforestry ecosystem in which a crop is grown in presence of a tree.

16. The method according to claim 4, wherein
the ecosystem includes an agroecosystem in which a plant is cultivated.

17. The method according to claim 4, wherein
the ecosystem includes a forest ecosystem.

18. The method according to claim 4, wherein
the ecosystem includes an agroforestry ecosystem in which a crop is grown in presence of a tree.
